(19) United States
(12) Patent Application Publication
(10) Pub. No.: US 2008/0228570 A1
(43) Pub. Date: Sep. 18, 2008

(54) Method of offering savings on pet-related products and services via club memberships while earning money toward a higher education

(76) Inventor: Michael S. Francis, Pittsburgh, PA (US)

Correspondence Address: Bryan H. Opalko, Esquire;Buchanan Ingersoll & Rooney PC, One Oxford Centre, 301 Grant Street, 20th floor, Pittsburgh, PA, 15219, US

(21) Appl. No.: 11/724,939

(22) Filed: Mar. 16, 2007

(51) Int. Cl. G06Q 30/00

(52) U.S. Cl. 705/14; 705/39

(57) ABSTRACT

A method of offering and selling club memberships is provided, which includes generally the steps of providing a club that may offer its members discounts on pet-related products and/or services, registering/engaging individuals (e.g., pre-college age youth) to promote the club to prospective members, and crediting money to a financial savings/investment account in the name of respective pre-college age youth when individuals solicited by the respective pre-college age youth join and become members of the club. In one form, the club includes a web-based club having a club website accessible via the Internet which members can access to receive discounts on pet-related products and/or services. Additionally, club members receive a predetermined discount off of veterinary services as a benefit of becoming a member. The amount of the discount may depend on the level of membership purchased.

### FIELD OF THE INVENTION

The present invention is directed toward offering club memberships in which members receive savings on pet-related products and services and, more particularly, toward a web-based, club membership, pet health care discount offering in which pre-college age youth can receive credits convertible to money to be deposited in IRS sanctioned college savings accounts for higher education tuition, fees, etc. for promoting the club and encouraging pet owners to join.

### BACKGROUND OF THE INVENTION

In today's society, people are becoming more and more involved with their pets. For many people, owning a pet is not merely considered a hobby; many pet owners regard their pets as members of their family and treat them as such. As a result of this trend, pet owners are generally willing to go to great lengths, financially, to help ensure the health and safety of their pets. However, with the rising cost of veterinary care, pet owners may not have the funds available when needed to defray the cost of veterinary care and thereby adequately care for their pets. This is especially true in the event of an unforeseen illness or accident.

Pet insurance is a known vehicle which is available in the marketplace for helping to alleviate the generally high cost of healthcare for pet owners. While veterinary care has become increasingly sophisticated, it has also become increasingly expensive, especially for pet owners who are not prepared for an unexpected illness or accident. Pet insurance can help alleviate the tragic situation of being forced to put a price tag on the life of one's pet.

Pet insurance (actually property and casualty insurance) is much like conventional health insurance, in which a pet owner enrolls his or her pet in a pet insurance plan. Pet insurance providers generally offer various types of plans and coverages. For example, the injury or illness must be considered an eligible event, and various types of plans with various deductibles are available to choose from, again much like conventional personal health insurance plans. Typically, pets must pass an eligibility test in order to be a candidate for pet insurance.

Generally, after enrollment, pet insurance works by taking one's pet to a veterinarian, paying for their services, and then submitting a claim form along with the receipt(s). After a certain deductible is met, a pet insurance plan generally reimburses the pet owner for a certain percentage of covered, allowable veterinary visits within a preset number of days from receiving the claim. Depending on the type of pet insurance plan chosen, a pet owner may take his/her pet to any licensed veterinarian, or may be restricted to only those veterinarians within the plan network (i.e., in-network vs. out-of-network). Often times, different deductibles and/or coverage amounts may apply depending upon whether the veterinarian is in-network or out-of-network.

“Pet assurance” is a viable alternative to pet insurance. Similar to pet insurance, pet assurance helps alleviate the generally high cost of veterinary care. However, with pet assurance, there are typically no claim forms to submit and no deductibles to meet. Additionally, pet assurance typically does not contain any exclusion for certain procedures or care, and pre-existing conditions are typically covered. However, pet assurance, as it is currently being offered in the marketplace today, still requires that the veterinarian visited be “in-network” in order for the pet assurance benefits to apply.

Pet assurance typically works by the pet owner purchasing a plan for a predetermined price. Typically, the price of pet assurance will depend on the number of pets enrolled and, possibly, the type of pet(s). The pet owner must then take his/her pet to a veterinarian who is part of the pet assurance network. To become a member of the network, typically a veterinarian will be required to agree to provide members with a preset discount (typically a predetermined percentage) off of their veterinary bill. This discount is taken off of the bill at the vet's office, and the pet owner is not required to fill out or submit any claim forms. The veterinarian is typically not reimbursed for the discount offered and must absorb the discount. The vet agrees to provide the discount to members in return for becoming a member of the pet assurance network. However, as previously noted, a requirement of pet assurance is that the pet owner must take his/her pet to a veterinarian within the network in order to be able to receive the discount.

With pet owners becoming more and more increasingly dedicated to their pets, both pet insurance and pet assurance have become popular options for assisting pet owners in managing the costs of caring for their pets.

On an unrelated topic, the cost of higher education (i.e., college) in the United States has become increasingly and increasingly more expensive. It has gotten to the point where many kids today will simply be unable to afford the high cost of a college education. While financial aid is available, many children of working families simply do not qualify. Often, the family earns too much to qualify for federal or state need-based grants, but does not earn enough to completely pay for college expenses.

Additionally, while many forms of financial aid are available, the application process is often confusing and tedious, providing an obstacle to obtaining funds sufficient to pay for a college education.

One alternative is for the student to take out a loan. Payments on certain loans may be deferred until the student completes college. However, interest may continue to accrue. A loan has the disadvantage in that the student may have loan debt of $100 k or more upon graduation, especially if a graduate degree is obtained. This can be a tremendous burden for someone who is just starting out in the working world.

The present invention is directed toward overcoming one or more of the above-identified problems.

### SUMMARY OF THE INVENTION

A method of offering and selling club memberships is provided in accordance with the present invention, which includes generally the steps of providing a club that may offer its members discounts on pet-related products and/or services, registering/engaging individuals (e.g., pre-college age youth) to promote the club to prospective members, and crediting money to a financial savings/investment account in the name of respective pre-college age youth when individuals solicited by the respective pre-college age youth join and become members of the club. In one form, the club includes a web-based club having a club website accessible via the Internet which members can access to receive discounts on pet-related products and/or services. In a further form, club members receive a predetermined discount off of veterinary services as a benefit of becoming a member. The amount of the discount may depend on the level of membership purchased.

Club members may be issued a club credit card directly from a bank or other financial institution, which the member can use for general purchases. Respective pre-college age youth receive monetary credits to their financial savings/investment account each time a member solicited by the respective pre-college age youth uses the club credit card to make a purchase.

In an additional form, the pre-college age youth receive credits, or points, for each new member and each time the club credit card is used. These credits are periodically redeemable for dollars deposited to the financial savings/investment account in the name of the respective pre-college age youth. The financial savings/investment account may be specifically directed toward use for higher level education (i.e., a 529-college savings account), and the pre-college age youth may have no input as to where monies in the account are invested.

The monies credited to the financial savings/investment account are available to the pre-college age youth for a predetermined period of time after the pre-college age youth reaches a predetermined age. If the pre-college age youth dies before reaching the predetermined age, those monies in the pre-college age youth's financial savings/investment account may be: (a) transferred to a general scholarship fund managed by the club; (b) provided to a beneficiary designated by the pre-college age youth; or (c) utilized for an honorary scholarship in the name of the deceased pre-college age youth.

It is thus an object of the present invention to marry the unrelated concepts of assisting pet owners in managing the costs of caring for their pets with an adolescent attempting to raise money for a college education. The inventive methodology provides a means by which both the pet owner and the adolescent may benefit.

Other objects, aspects and advantages of the present invention can be obtained from a study of the specification and the appended claims.

### DETAILED DESCRIPTION OF THE INVENTION

The present invention includes a method which is directed toward offering and providing a club-type organization that provides its members with discounts on pet-related products and services, such as, but not limited to, veterinary bills, lost pet I.D. chips, an array of pet care-amusement-grooming-training products/services, pet insurance, pet assurance, etc.

The present invention generally consists of a club membership that is available via the Internet. A prospective member can access the club's website and view the various benefits of becoming a member. To become a member, the individual will typically register for a membership over the Internet and pay a membership fee. It is contemplated that various levels of memberships may be offered. Generally, the more costly the membership, the greater the level of benefits offered/provided to the member. Membership fees may be payable periodically (e.g., yearly) in order to be able to continue to enjoy club benefits. Additionally, an up-front initiation fee may also be required in addition to the periodic membership fee. In an alternate form, lifetime club memberships may be offered.

The club website generally consists of two portions; a public portion accessible by the general public and a private portion accessible only by members. Typically, a username and password will be required to access the “members only” portion of the website. In one form, the members only portion of the website is divided into three areas, including a goods/services area (“eProducts”), a forum area (“eLife”) and a trading area (“eMart”). It should be understood that these areas are exemplary only, and the members only portion of the website may be configured in any fashion to provide benefits to club members. Upon authorization (i.e., entering a valid username and password), the club member can access any of the areas included within the members only portion.

The eProducts area provides club members with various discount offerings at various levels of discounts for pet-related products and/or services. These can include, but are not limited to, discounts on veterinary bills (e.g., pet insurance or pet assurance), lost pet I.D. chips, food/nutritional items and an array of pet care-amusement-grooming-training products and services. The discounts may be in the form of coupons which may be printed and redeemed by the club member, or the discounted products and/or services may be purchased directly, via the club or via the manufacturer/retailer, over the Internet by conventional e-commerce techniques.

The eLife area is a forum section for club members. It is a private virtual community where pet owners can share pet photos, videos, journals, etc., and may also include chat rooms and/or blogs where pet owners may communicate with one another and share information, opinions and experiences. Educational information, pet health tips, pet resources and links to other related sites may also be provided to the club member.

The eMart area essentially provides an online trading platform for a diverse and passionate community of pet owners and business (who may also be members). Club members may initiate “for sale” or “wanted” posts in the eMart area, and virtually any type of pet-related products or services, including pets themselves, may be traded and/or sold among club members in the eMart area.

The public portion of the website may also include discount offerings for pet-related products and/or services, and may also include educational information and links to other related sites. However, the public discounts and offerings will not be as extensive as those provided to club members, in order to entice individuals into becoming members. The public portion of the club website will include information about the benefits of becoming a club member, and will include a registration form which may be filled out online and submitted electronically (or alternately, printed and submitted by mail/fax). In an alternate form, the public portion of the website may also include eProducts, eLife and eMart areas, albeit to a lesser extent than provided in the members only area since the goal is to entice individuals into becoming club members to receive the enhanced benefits.

A contemplated benefit of becoming a club member is that members will receive a significant cost discount on veterinary services. The discount will be in the form of a certain percentage off of such services. The percentage may vary with the level of membership purchased. For example, a lower level member may receive 10% off veterinary visits, while a higher level member may receive 25% off. Additionally, other benefits may affect the level, and hence cost, of the membership. The exact percentage discount is not germane to the present invention, and any percentage discount may be implemented without departing from the spirit and scope of the present invention.

To receive the discount, the club member simply mails in a copy of the veterinary bill to the club, and the club will send the member a check for the discounted amount. Unlike “pet assurance” where the vet absorbs the discount as a cost of being included in the network, the present invention contemplates that the club will pay the discounted amount to the member from initiation fees and/or other working capital or revenue. Further, the present invention contemplates that no network is needed (i.e., no in-network vs. out-of-network distinction), and the pet owner may take his/her pet to the veterinarian of their choice and still receive the discount. However, in an alternate form of the present invention, the discount offering to members for veterinary services may work in a manner similar to conventional pet assurance programs where the veterinarian must be in-network in order for the discount to apply.

A further contemplated benefit of club membership is that each member may receive his/her own club credit card issued by a bank or other financial institution. As part of the registration process, the member will fill out an application for the credit card, and the club credit card will be issued to the member with a determined credit limit in accordance with conventional credit card application techniques. The club credit card is essentially a standard Visa®, MasterCard®, Discover®, etc., and will be issued in the name of the member. In a preferred form, the club will assume no obligations with respect to purchases made using the club credit card; the contract is simply between the club member and the bank or other financial institution. The club credit card may be used to purchase products and/or services from the club website, and may also be used for any other general purchases. The importance of the club credit card as it pertains to earning higher level education dollars will be described hereafter.

In addition to providing pet owners with discounts for pet-related products and/or services, as well as other member benefits, the present invention also provides adolescents (pre-college age youth) with a means by which they can earn money that may be used to pay for a college, or other higher level, education. In order to make the public aware of the club and its benefits to pet owners, the club will offer an initiative to adolescents who wish to “sell”, actually promote the sale of, club memberships door to door, or by any other perceived means. The club website will typically include a link that the adolescent, possibly with his/her parent or legal guardian, may visit and learn about the club and the ability to earn money for a higher level education. After reviewing information about the club and deciding that he/she wishes to participate in the program, the adolescent will enroll by registering, via the club website or other means, with the club. Upon registering in the program, the adolescent may be sent a kit, which will assist him/her in promoting the club to prospective members. The adolescent will also be provided with an ID code, which should be given to each prospective member that the adolescent visits. In a preferred form, the adolescent may go door to door making individuals aware of the club and its benefits, and urging the prospective members to visit the club website and join. The adolescent will provide the prospective members with his/her ID code, and instruct them to input the ID code in the appropriate field when they register to join the club. In this manner, the adolescent will be given credit for essentially “selling”, actually promoting the sale of, a club membership, which will be tracked by his/her ID code.

In addition, the adolescent will have an account set up in his/her name into which funds will be deposited for use towards a higher level education. This account may be in the form of a 529-college savings account, which is specifically directed toward use for higher level education, or may be any other type of financial savings/investment account. In a preferred form, the adolescent will not have any input as to where the monies are invested. It is contemplated that the monies in the account will be invested by the club in low or no risk bonds; however, other investment methodologies may be implemented without departing from the spirit and scope of the present invention. Additionally, other accounts where the adolescent may choose and direct where his/her monies in the account are invested are also contemplated. Money is credited to these accounts based both upon club memberships and club credit card usage in a manner described as follows.

When the prospective member visits the club website and registers to become an actual member, he or she will input that adolescent's particular ID code in the appropriate field. The adolescent will be given credit for the membership in the form of a monetary amount credited to his/her account. The amount credited may depend upon the level of membership purchased. While the account may be in the name of the adolescent, the club may maintain the account, and the adolescent may not have direct access to any monies deposited in the account. Thus, the more memberships the adolescent is credited for, the more money that will be deposited in his/her account.

It is understood that in registering to become a member, individuals may misplace or simply forget to enter the adolescent's ID code. To help ensure that each adolescent is given appropriate credit for club memberships, each adolescent may submit a list of the names and addresses of individuals that they have approached promoting the club. These lists may be compared against the club membership list to help ensure that each adolescent is given credit for the memberships they have initiated.

As previously discussed, each member of the club is provided with a club credit card, which may be used for any type of purchase. As a further benefit to the adolescent, each time the club member uses the club credit card for a purchase (of whatever nature), the adolescent will be credited a certain amount to his/her account. In a preferred form, the amount credited to the adolescent's account will depend upon the amount purchased using the club credit card. However, other crediting methodologies for use of the club credit card may be implemented without departing from the spirit and scope of the present invention.

Thus, through implementation of the inventive method, the more club memberships an adolescent is responsible for, the more money he/she will earn toward a higher level education. Additionally, the more the club credit card is used by those club members the adolescent is responsible for, the more money he/she will earn toward a higher level education.

The monies that are credited to the adolescent's account (both from club memberships and use of the club credit card), in one form, are designated strictly for higher level educational purposes. When the adolescent reaches a certain age (e.g., age 18 or any other age that may be determined), those monies present in the adolescent's account are expected to be available solely for higher level educational purposes. (As used herein, higher level education shall mean any educational endeavor above that of the high school level.) Those monies will be available for a predetermined period of time (e.g., 1 or 2 years, or any other time period that is determined) for higher level educational purposes. If, within the predetermined time period, the monies are not put to use for higher level education, the invention contemplates that the monies may be transferred to a general scholarship fund which will be managed and provided by the club on a periodic basis (e.g., yearly or any other interval that is determined). In one form, to ensure that the monies are used for higher level education, the monies may not be paid directly to the adolescent but, rather, may be payable by the club directly to a higher level educational institution at the direction of the adolescent or his/her parent or guardian.

In the unfortunate circumstance where an adolescent dies before being able to cash in all of his/her higher education dollars, those amounts remaining in his/her account may be utilized for an honorary scholarship in the name of the deceased adolescent. Either the club or the deceased adolescent's surviving parents/guardians (or other surviving relative) may oversee the honorary scholarship, and any perceived means of choosing a recipient may be implemented without departing from the spirit and scope of the present invention. In an alternate form of the present invention, the adolescents may designate a beneficiary who will receive those monies in the event of the adolescent's death. In yet a further form, those monies present in a deceased adolescent's account may be transferred to the general scholarship fund managed by the club.

In a further embodiment of the present invention, monies are earned by an adolescent in the form of points or credits. Adolescents will receive points for promoting the club to pet owners door to door, or by any other perceived means. When the prospective club member visits the club website and registers to become a member, he/she will input that adolescent's particular ID code. Points will be credited to the adolescent's account for the new club member's initial login to the club website, and the amount of points earned may depend on the level of membership purchased. All subsequent activity of the club member, will result in points being earned for the adolescent, including use of the club credit card and the purchase of pet-related products and services via the club website (points may be awarded for purchases via the club website whether the club credit card is used or not for those purchases). On a periodic basis (e.g., quarterly), the points will be redeemed for dollars deposited to an individual financial savings/investment account specifically directed toward use for higher level education for the adolescent. The adolescent will have access to his/her account to watch it grow.

It is understood that individuals may learn about and visit the club website on their own. In these instances, no ID code will be input, and no particular adolescent will receive credit for the membership, use of the club credit card, etc. The present invention contemplates that, in these instances, those monies/points set aside for club memberships, club credit card usage, etc. will be deposited into the general scholarship fund. Any adolescent may apply for the general scholarship, and the club, based on criteria set by the club, may periodically award such scholarships.

Thus, the present invention provides a means by which adolescents can earn money for higher level education, while helping to provide pet owners with a peace of mind that they will be financially able to provide for the well being of their pets.

The present invention provides a unique methodology by which both pet owners and adolescents seeking a higher level education may benefit. While the present invention has been described with particular reference to a preferred embodiment(s), it should be understood, and one of ordinary skill in the art will understand, that various modifications can be made to the methodology of the present invention without departing from the spirit and scope thereof. For example, while the present invention has been described as only allowing the monies earned by adolescents to be used for a higher level education, these monies may be readily withdrawn by the adolescent or his/her parent or guardian for any purpose without departing from the spirit and scope of the present invention. Additionally, while the present invention has been described as offering club memberships for pet owners, any type of club membership may be implemented without departing from the spirit and scope of the present invention.

I claim:

1. A method comprising the steps of:
providing a club that offers its members discounts on pet-related products and/or services;
engaging pre-college age youth to promote the club to prospective members; and
crediting money to a financial savings/investment account in the name of respective pre-college age youth when individuals solicited by the respective pre-college age youth become members of the club.

2. The method of claim 1, wherein the club comprises a web-based club having a club website which members can access to receive discounts on pet-related products and/or services.

3. The method of claim 1, wherein club members are issued a club credit card, and wherein respective pre-college age youth receive monetary credits to their financial savings/investment account each time a member solicited by the respective pre-college age youth uses the club credit card to make a purchase.

4. The method of claim 1, wherein money credited to a pre-college age youth's financial savings/investment account is available to the pre-college age youth for a predetermined period of time after the pre-college age youth reaches a predetermined age.

5. The method of claim 4, wherein monies credited to the financial savings/investment account may only be used by the pre-college age youth to cover higher level educational costs.

6. The method of claim 4, wherein if a pre-college age youth dies before reaching the predetermined age, those monies in the pre-college age youth's financial savings/investment account will be:
(a) transferred to a general scholarship fund managed by the club;
(b) provided to a beneficiary designated by the pre-college age youth; or
(c) utilized for an honorary scholarship in the name of the deceased pre-college age youth.

7. The method of claim 1, wherein when an individual joins the club who has not been solicited by any pre-college age youth, monetary credits are made to a general scholarship fund.

8. The method of claim 1, where club members receive a predetermined discount off of veterinary services.

9. A method of offering and selling club memberships comprising the steps of:
registering individuals to promote the sale of club memberships; and
crediting money to a financial savings/investment account in a name of a respective individual when a person solicited by the respective individual becomes a member of the club.

10. The method of claim 9, wherein the club is a web-based club having a club website which members can access to receive discounts on pet-related products and/or services, and wherein club members receive a predetermined discount off of veterinary services.

11. The method of claim 9, wherein club members are issued a club credit card, and wherein individuals registered to promote the sale of club memberships receive monetary credits to their financial savings/investment account each time a member solicited by the respective individual uses the club credit card to make a purchase.

12. The method of claim 11, wherein individuals registered to promote the sale of club memberships are issued credits for initial club memberships and use of the club credit card, and wherein the credits are redeemed for dollars deposited to the respective individual's financial savings/investment account on a periodic basis.

13. The method of claim 9, wherein the individuals registered to promote the sale of club memberships comprise pre-college age youth, and wherein monies credited to a respective pre-college age youth's financial savings/investment account may only be used to cover higher level educational costs.

14. The method of claim 13, wherein money credited to a pre-college age youth's financial savings/investment account is available to the pre-college age youth for a predetermined period of time after the pre-college age youth reaches a predetermined age.

15. The method of claim 14, wherein if a pre-college age youth dies before reaching the predetermined age, those monies in the pre-college age youth's financial savings/investment account will be:
(a) transferred to a general scholarship fund managed by the club;
(b) provided to a beneficiary designated by the pre-college age youth; or
(c) utilized for an honorary scholarship in the name of the deceased pre-college age youth.

16. The method of claim 13, wherein when an individual joins the club who has not been solicited by any pre-college age youth, monetary credits are made to a general scholarship fund.

17. The method of claim 9, wherein individuals registered to promote the sale of club memberships have no input as to where the monies deposited in their financial savings/investment account are invested.

18. A method of offering and selling club memberships comprising the steps of:
issuing credits to individuals registered to promote the sale of club memberships when a person solicited by the respective individual becomes a member of the club, wherein the credits are periodically redeemable for dollars deposited to a financial savings/investment account in the name of the respective individual.

19. The method of claim 18, wherein club members are issued a club credit card, and wherein individuals registered to promote the sale of club memberships receive credits each time a member solicited by the respective individual uses the club credit card to make a purchase, wherein the credits are periodically redeemable for dollars deposited to a financial savings/investment account in the name of the respective individual.

20. The method of claim 19, wherein the individuals registered to promote the sale of club memberships comprise pre-college age youth, and wherein the financial savings/investment account is specifically directed toward use for higher level education.
